(19) United States
(12) Patent Application Publication
(10) Pub. No.: US 2010/0078077 A1
(43) Pub. Date: Apr. 1, 2010

(54) Spacers for Microfluidic Channels

(76) Inventors: Rustem F. Ismagilov, Chicago, IL (US); Delai L. Chen, Chicago, IL (US); Liang Li, Chicago, IL (US); Wenbin Du, Chicago, IL (US)

Correspondence Address: BRINKS HOFER GILSON & LIONE, P.O. BOX 10395, CHICAGO, IL, 60610, US

(21) Appl. No.: 12/520,027

(22) PCT Filed: Dec. 19, 2007
(86) PCT No.: PCT/US07/26028

§ 371 Date: Jul. 16, 2009

Related U.S. Application Data
(60) Provisional application No. 60/875,856, filed on Dec. 19, 2006.

(51) Int. Cl. F16K 99/00

(52) U.S. Cl. 137/1; 137/861

(57) ABSTRACT

A microfluidic system comprises a microchannel, a carrier fluid in the microchannel, and at least two plugs in the microchannel. Each plug comprises a plug fluid that is substantially immiscible with the carrier fluid. The microfluidic system further comprises at least one spacer in the microchannel between two plugs. Each spacer comprises a spacer fluid that is substantially immiscible with the carrier fluid and the plug fluid, and both of the following conditions are satisfied: (γ_{c-r}+γₜ₋ᵣ>γ_{c-t}) and (γ_{c-t}+yₜ₋ᵣ>y_{c-r}), where γ_{c-r} is the interfacial force between the carrier fluid and the plug fluid, γₜ₋ᵣ is the interfacial force between the spacer fluid and the plug fluid, and γ_{c-t} is the interfacial force between the carrier fluid and the spacer fluid.

The present application claims priority to U.S. Provisional Patent Application Ser. No. 60/875,856, filed Dec. 19, 2006, the entirety of which is hereby incorporated by reference.

This invention was made with government support under grant number DMR0213745 awarded by the National Science Foundation (NSF) and grant number GM074961 awarded by the National Institutes of Health (NIH). The government has certain rights in the invention.

### FIELD OF THE INVENTION

The present invention relates to spacers for microfluidic channels. More particularly, the present invention relates to using three-phase flow of immiscible liquids or hydrophobic particles to prevent coalescence of droplets in microfluidic channels.

### BACKGROUND OF THE INVENTION

Discrete microfluidic plugs (droplets large enough to fill the cross section of a microfluidic channel) dispersed in an immiscible carrier fluid have been used in protein crystallization, synthesis of microparticles (including vesicles and capsules) and double emulsions, enzymatic assays, protein expression, and screening reaction conditions. Coalescence of neighboring plugs, however, can cause contamination of reagents, change the size of plugs, and make it difficult to locate an individual plug within a sequence of plugs. Coalescence is driven by interfacial energy and can occur when two plugs of the same phase catch up and come into contact as a result of the relative motion of plugs during flow. Relative motion is more likely for adjacent plugs containing solutions of different viscosities or interfacial tensions. Even for plugs containing the same solution, relative motion may take place if the sizes of adjacent plugs are different, a phenomenon that was previously used to direct the coalescence of plugs. Coalescence may be suppressed by loading the liquid-liquid interfaces with detergents or colloidal particles, but this manipulation of interfaces may be undesirable for some applications. For example, some detergents cause proteins to adsorb to the fluid interface. It is thus desirable to eliminate coalescence by preventing direct contact of adjacent reagent plugs.

Gas bubbles were previously used to separate reagent plugs, resulting in a three-phase flow of gas-reagent-carrier. Gas bubbles were used in liquid-gas two phase segmented flow as well. For applications involving long arrays of plugs, there are two drawbacks in using gas bubbles as spacers. First, compressible gas bubbles could cause flow fluctuation and a lag in response to the change of flow rates in pressure-driven flow. Second, gas bubbles may dissolve in a fluorinated carrier fluid under high pressure. It is thus desirable to solve these problems such that spacers could be useful when performing screens using cartridges preloaded with reagent plugs. In these screens, a stream of a substrate solution is injected into plugs in a preformed array through a T-junction, with each plug containing a solution of a different composition.

A preferred embodiment of the present invention provides hydrophobic particles or plugs of a third immiscible liquid as spacers to prevent coalescence of adjacent reagent plugs.

### BRIEF SUMMARY OF THE INVENTION

In one embodiment, a microfluidic system comprises a microchannel, a carrier fluid in the microchannel, and at least two plugs in the microchannel. Each plug comprises a plug fluid that is substantially immiscible with the carrier fluid. The microfluidic system further comprises at least one spacer in the microchannel between two plugs. Each spacer comprises a spacer fluid that is substantially immiscible with the carrier fluid and the plug fluid, and both of the following conditions are satisfied: (γ_{c-r}+γₜ₋ᵣ>γ_{c-t}) and (γ_{c-t}+γₜ₋ᵣ>γ_{c-r}), where γ_{c-r} is the interfacial force between the carrier fluid and the plug fluid, γₜ₋ᵣ is the interfacial force between the spacer fluid and the plug fluid, and γ_{c-t} is the interfacial force between the carrier fluid and the spacer fluid.

In another embodiment, a microfluidic system comprises a microchannel, and a carrier fluid in the microchannel. The carrier fluid comprises a fluorinated oil. The microfluidic system also comprises at least two plugs in the microchannel. Each plug comprises an aqueous plug fluid. The microfluidic system further comprises at least one spacer in the microchannel between two plugs. The at least one spacer comprises a spacer fluid comprising a compound selected from the group consisting of a partially fluorinated compound and a siloxane compound.

In yet another embodiment, a method of separating two plugs in a microfluidic channel comprises providing a microfluidic channel filled with a carrier fluid and at least two plugs. Each plug comprises a plug fluid that is substantially immiscible with the carrier fluid. The method of separating two plugs in a microfluidic channel further comprises introducing at least one spacer in the microchannel between two plugs, wherein each spacer comprises a spacer fluid that is substantially immiscible with the carrier fluid and the plug fluid, and wherein both of the following conditions are satisfied: (γ_{c-r}+γₜ₋ᵣ>γ_{c-t}) and (γ_{c-t}+γₜ₋ᵣ>γ_{c-r}), where γ_{c-r} is the interfacial force between the carrier fluid and the plug fluid, γₜ₋ᵣ is the interfacial force between the spacer fluid and the plug fluid, and γ_{c-t} is the interfacial force between the carrier fluid and the spacer fluid.

In a further embodiment, a method of separating two plugs in a microfluidic channel comprises providing a microfluidic channel filled with a carrier fluid and at least two plugs. Each plug comprises a plug fluid that is substantially immiscible with the carrier fluid. The method of separating two plugs in a microfluidic channel further comprises introducing at least one spacer in the microchannel between two plugs, wherein each spacer comprises a spacer fluid comprising a compound selected from a group consisting of a partially fluorinated compound and a siloxane compound.

In one embodiment, a microfluidic system comprises a microchannel, a carrier fluid in the microchannel, and at least two plugs in the microchannel. Each plug comprises a plug fluid that is substantially immiscible with the carrier fluid. The microfluidic system further comprises at least one spacer in the microchannel between two plugs. Each spacer comprises at least one hydrophobic particle. The spacer maintains the separation of the plugs that contact the spacer.

In another embodiment, a method of separating two plugs in a microfluidic channel comprises providing a microfluidic channel filled with a carrier fluid and at least two plugs. Each plug comprises a plug fluid that is substantially immiscible with the carrier fluid. The method of separating two plugs in a microfluidic channel further comprises introducing at least one spacer in the microchannel between two plugs. Each spacer comprises a spacer fluid and at least one hydrophobic particle. The spacer maintains the separation of the plugs that contact the spacer.

### BRIEF DESCRIPTION OF THE DRAWINGS

FIG. 1 illustrates a method to predict engulfing of plugs by analyzing the interfacial tensions.

FIG. 2 illustrates separation of alternating plugs containing solutions of different viscosities with SID plugs.

FIG. 3 illustrates separation of aqueous plugs of different viscosities using SID plugs.

FIG. 4 illustrates separation of aqueous plugs of different viscosities using hydrophobic particles.

### DETAILED DESCRIPTION OF THE INVENTION

The various embodiments described herein are in the context of using a third liquid and hydrophobic particles as spacers in a microfluidic system. One of ordinary skill in the art will appreciate that other compositions having the same or different properties may be used as spacers in accordance with the teachings herein. Therefore, reference to the third liquid and hydrophobic particles is to be understood to be illustrative and not limiting the invention. Microfluidic systems have been described by the present inventors in U.S. Pat. No. 7,129,091, U.S. Pat. Appl. Pub. Nos. 2005/0087122, 2006/0003439, 2006/0094119, and 2007/0172954, and U.S. Provisional Pat. Appl. Ser. Nos. 60/379,927, 60/394,544, 60/585,801, 60/623,261, 60/763,574, 60/875,856, 60/881,012, 60/899,449, 60/930,316, 60/936,606, and 60/962,426, each of which is incorporated herein by reference in their entireties.

In the following discussion, the term “third liquid” refers to any liquid immiscible with the carrier fluid and the plug fluid. The term “spacers” refers to any spacers. Suitable spacers include, but are not limited to, at least one liquid (e.g., ionic liquids, fluorosilicones, hydrocarbons, and fluorinated liquids), gas (preferably an inert gas such as nitrogen, argon or xenon), gel or solid (e.g., polymers such as polystyrene) that is immiscible with both the plug fluid and the carrier. Preferably, the spacers are third liquids or hydrophobic particles that are effective in preventing coalescence.

Spacers can also contain markers so they can be used to index plugs. Spacers may also be used to reduce cross communication (e.g. by preventing optical communication or by preventing permeability) between plugs. Spacers may also have functional properties.

In one example, spacers can be formed and manipulated using the methods similar to those used for formation and manipulation (e.g. splitting) of plugs composed of a liquid. In particular, a stream composed of both liquid plugs and third liquid spacers may be formed using the same methods used to form streams of plugs of alternating liquid compositions. Spacers may be introduced during robotic fabrication of the array. If an array of larger plugs separated by spacers is split to fabricate several arrays of smaller plugs, then the spacers are preferably also split.

Spacers can play an important role in manipulations of plugs. First, if undesirable merging of plugs occurs, spacers can be inserted between the plugs to minimize merging. Such spacers may allow transport of an array of plugs through longer distances than without the spacers. Such spacers may also facilitate transfer of plugs in and out of devices and capillaries (or transfer through composite devices made of combinations of devices and capillaries).

In one embodiment, a microfluidic system comprises a microchannel, a carrier fluid in the microchannel, and at least two plugs in the microchannel. Each plug comprises a plug fluid that is substantially immiscible with the carrier fluid. The microfluidic system further comprises at least one spacer in the microchannel between two plugs. Each spacer comprises a spacer fluid that is substantially immiscible with the carrier fluid and the plug fluid, and both of the following conditions are satisfied: (γ_{c-r}+γₜ₋ᵣ>γ_{c-t}) and (γ_{c-t}+γₜ₋ᵣ>γ_{c-r}), where γ_{c-r} is the interfacial force between the carrier fluid and the plug fluid, γₜ₋ᵣ is the interfacial force between the spacer fluid and the plug fluid, and γ_{c-t} is the interfacial force between the carrier fluid and the spacer fluid.

In one example, the carrier fluid is an oil. Preferably, the carrier fluid is a fluorinated oil. The plug fluid may be water. In one example, the plug fluid includes a detergent. Any spacer fluid that satisfies the condition discussed above can be used. For example, the spacer fluid can be a partially fluorinated compound. In one example, the spacer fluid is dimethyl tetrafluorosuccinate. In another example, the spacer fluid is a siloxane compound. In one case, the spacer fluid is 1,3-diphenyl1,1,3,3-tetramethyldisiloxane.

In another embodiment, a microfluidic system comprises a microchannel, and a carrier fluid in the microchannel. The carrier fluid comprises a fluorinated oil. The microfluidic system also comprises at least two plugs in the microchannel. Each plug comprises an aqueous plug fluid. The microfluidic system further comprises at least one spacer in the microchannel between two plugs. The at least one spacer comprises a spacer fluid comprising a compound selected from the group consisting of a partially fluorinated compound and a siloxane compound.

In yet another embodiment, a method of separating two plugs in a microfluidic channel comprises providing a microfluidic channel filled with a carrier fluid and at least two plugs. Each plug comprises a plug fluid that is substantially immiscible with the carrier fluid. The method of separating two plugs in a microfluidic channel further comprises introducing at least one spacer in the microchannel between two plugs, wherein each spacer comprises a spacer fluid that is substantially immiscible with the carrier fluid and the plug fluid, and wherein both of the following conditions are satisfied: (γ_{c-r}+γₜ₋ᵣ>γ_{c-t}) and (γ_{c-t}+γₜ₋ᵣ>γ_{c-r}), where γ_{c-r} is the interfacial force between the carrier fluid and the plug fluid, γₜ₋ᵣ is the interfacial force between the spacer fluid and the plug fluid, and γ_{c-t} is the interfacial force between the carrier fluid and the spacer fluid.

In one example, the carrier fluid is an oil. The plug fluid may be water. The spacer fluid may vary. For example, the spacer fluid is a partially fluorinated compound or a siloxane compound. Preferably, each plug is separated from another by a spacer. The shape of the microchannel may vary. For example, the microchannel may have a T-junction to split the plugs. The microchannel may have a substantially square shape or a substantially circular shape. The material that the microchannel is made of may vary. In one example, the microchannel is made of polydimethylsiloxane.

In a further embodiment, a method of separating two plugs in a microfluidic channel comprises providing a microfluidic channel filled with a carrier fluid and at least two plugs. Each plug comprises a plug fluid that is substantially immiscible with the carrier fluid. The method of separating two plugs in a microfluidic channel further comprises introducing at least one spacer in the microchannel between two plugs, wherein each spacer comprises a spacer fluid comprising a compound selected from a group consisting of a partially fluorinated compound and a siloxane compound.

In one embodiment, a microfluidic system comprises a microchannel, a carrier fluid in the microchannel, and at least two plugs in the microchannel. Each plug comprises a plug fluid that is substantially immiscible with the carrier fluid. The microfluidic system further comprises at least one spacer in the microchannel between two plugs. Each spacer comprises at least one hydrophobic particle. The spacer maintains the separation of the plugs that contact the spacer.

Preferably, the spacer further comprises a spacer fluid. The spacer fluid may be the same as the carrier fluid. Alternatively, the spacer fluid may be different from the carrier fluid. Preferably, the spacer fluid is substantially immiscible with the carrier fluid and the plug fluid. Suitable particles useful for spacers include, but are not limited to, glass bubbles, silica gels, silica microspheres, hollow glass beads, and pollens. Preferably, the at least one hydrophobic particle is fluorinated. In one example, the spacer particles can be treated to have different colors. The colored particle spacers can be used to index different plugs. Preferably, the at least one hydrophobic particle is wetted by the carrier fluid.

The size of the at least one hydrophobic particle may vary. Preferably, the particle is about 15%-50% of the inner diameter of the microchannel. More preferably, the particle is about 30%-40% of the inner diameter of the microchannel. If the particle is too small relative to the microchannel, it may stay with the layer of the carrier oil coated on the inner wall of the microchannel and thus can not be moved by the carrier fluid. If the particle is too large, the carrier fluid may not be able to carry it either. The large particle may remain in and block the microchannel.

The particle may have any shape. Preferably, the at least one hydrophobic particle has a substantial spherical shape. Preferably, the at least one hydrophobic particle is suspended in the carrier fluid. The particle solution was shaken before use. In one example, the at least one hydrophobic particle substantially remains suspended in the spacer fluid when there is no flow in the microchannel.

In another embodiment, a method of separating two plugs in a microfluidic channel comprises providing a microfluidic channel filled with a carrier fluid and at least two plugs. Each plug comprises a plug fluid that is substantially immiscible with the carrier fluid. The method of separating two plugs in a microfluidic channel further comprises introducing at least one spacer in the microchannel between two plugs. Each spacer comprises a spacer fluid and at least one hydrophobic particle. The spacer maintains the separation of the plugs that contact the spacer.

The hydrophobic particle spacers as discussed above effectively prevent coalescence of different protein precipitant solutions. They provide stable flow rate and volume control. Moreover, the colored particles can be used to index various plugs, such as different protein precipitants.

Referring to FIG. 1, the conditions under which the third liquid can effectively prevent direct contact between reagent plugs were tested. Referring to FIG. 1a, the third liquid (t) and the reagent plug (r) are in substantially complete contact in a hypothetical starting position. This situation may be unstable because the interfacial forces between the carrier fluid (c), the reagent plug (r), and the third liquid (t) (represented by y, which is the interfacial force per unit length of the contact line) are not balanced. Referring to FIG. 1b, the interfacial forces equilibrate, and engulfing does not occur for high γₜ₋ᵣ. Referring to FIG. 1c, a third liquid plug separating reagent plugs was shown in a microphotograph. The third liquid was 1,3-Diphenyl-1,1,3,3-tetramethyldisiloxane (SID); the reagent was about 15% glycerol; and the carrier fluid was FC3283/PFO (about 10:1, v:v). Referring to FIG. 1d, the third liquid plug completely engulfs the reagent plug for low γₜ₋ᵣ. Referring to FIG. 1e, the third liquid engulfing a reagent plug was shown in a microphotograph. The third liquid was dimethyl tetrafluorosuccinate (DTFS); the reagent was water; and the carrier fluid was FC40.

Still referring to FIG. 1, when a plug of the third liquid was brought in contact with a reagent plug, the third liquid might form a plug clearly distinguishable from the reagent plug, or the third liquid might “engulf” the reagent plug (coat the reagent plug without coalescing). In the case of engulfing, the third liquid could transfer from one end of the reagent plug to the other during flow and not effectively prevent the direct contact or coalescence of reagent plugs. It is thus preferable to prevent the plug of third liquid from engulfing the reagent plug.

While not wishing to be bound by any theory, two assumptions were made in order to understand the factors affecting engulfing. First, the carrier fluid preferentially wets the channel, so that plugs of the third liquid and plugs of the reagent are surrounded by a thin film of the carrier fluid and do not touch the channel. This assumption ensures that plugs of the third liquid and reagent can be formed. Second, the capillary number (Cα) is small. Cα relates viscous forces to interfacial forces: Cα=ηU/γ, where η [kg m⁻¹ s⁻¹] is the viscosity, U [m s⁻¹] is the flow velocity, and γ [N m⁻¹] is the interfacial tension. This assumption assures that viscous forces are negligible compared to interfacial forces and that engulfing is dominated only by interfacial forces. The following abbreviations are used to denote the different interfaces: c-r, the interface between the carrier and the reagent; c-t, the interface between the carrier and the third liquid; and t-r, the interface between the third liquid and the reagent.

Referring to FIG. 1 again, in the three liquid system (carrier, reagent, and the third liquid), engulfing and non-engulfing correspond to the presence of different liquid-liquid interfaces. To prevent engulfing, both the c-r and c-t interfaces must be present. The t-r interface may or may not be present. In the case of engulfing, one of the two interfaces is missing: the c-r interface (third liquid engulfs the reagent plug) or the c-t interface (reagent engulfs the third liquid plug).

Still referring to FIG. 1, while not wishing to be bound by any theory, it is predicted, by comparing the interfacial tensions (γ), that engulfing will occur if either of these two inequalities is satisfied: γ_{c-t}>γₜ₋ᵣ+γ_{c-r} or γ_{c-r}>γₜ₋ᵣ+γ_{c-t}. Referring to FIG. 1b, a three-phase contact line is shown, along which the three interfacial forces balance. The three interfacial forces per unit length of the contact line correspond to γ_{c-t}, γ_{c-r}, and γₜ₋ᵣ. This balance requires the vectors corresponding to the three forces to be at equilibrium, which occurs only if the magnitude of every force is smaller than the sum of the magnitudes of the other two forces: γₜ₋ᵣ<γ_{c-t}+γ_{c-r} and γ_{c-r}<γ_{c-t}+γₜ₋ᵣ and γ_{c-t}<γₜ₋ᵣ+γ_{c-r}. This case is non-engulfing, because both c-r and c-t interfaces are present. If any of the three inequalities is not satisfied, the interfacial forces cannot be balanced, and one interface would be missing. For example, if γₜ₋ᵣ>γ_{c-t}+γ_{c-r}, the net force along the three-phase contact line will cause the s-r interface to shrink and be replaced by a layer of carrier fluid, a situation defined as the s-r interface being wet by the carrier. This case is also non-engulfing, because both the c-r and c-t interfaces are present, and the plug of the third liquid and the reagent plug are substantially completely separated by the carrier.

However, if γ_{c-t}>γₜ₋ᵣ+γ_{c-r}, the c-t interface will be wet by the reagent and will not be present; if γ_{c-r}>+γ_{c-r}, the c-r interface will be wet by the third liquid and will not be present. Both of these two are engulfing conditions. Similar analysis of interfacial tensions in three-phase flow has been previously used to understand the spontaneous motion of liquid slugs in a tube, where the three phases were a gas phase and two liquid phases that both wet the tube. While the above analysis focuses on balancing interfacial tensions at equilibrium, the analysis may be useful to understand nonequilibrium effects that may arise in this system during flow.

The interfacial tensions for 11 combinations of carrier fluid, reagent, and third liquid were measured to test these two criteria for engulfing. The reagent-third liquid interfaces were visualized in a Teflon capillary. In one example, it is desirable to identify third liquids that can be used for protein crystallization in microfluidic plugs, and fluorinated oils were chosen as the carrier fluids for their compatibility with protein crystallization. Water was used to mimic the reagent, because most protein crystallization is performed in aqueous solutions. An about 0.1% aqueous solution of a detergent, N,N-Dimethyldodecylamine N-oxide (LDAO), as the reagent was tested because detergents are usually used to solubilize membrane proteins. The use of detergents does not automatically solve the problem of plug coalescence, because the concentration and type of detergents are important parameters for the crystallization of membrane proteins and cannot be adjusted to stop coalescence.

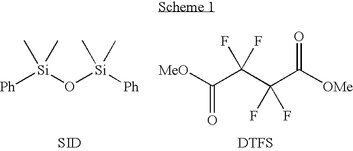

SID and DTFS were chosen as candidates for third liquids (Scheme 1). Both liquids are likely to provide high interfacial tensions with water and should be stable under typical conditions for protein crystallization. SID is a disiloxane bearing two phenyl groups. It was chosen over other methyldisiloxanes because it is less likely to swell polydimethylsiloxane (PDMS) microfluidic devices used for protein crystallization. DTFS is a partially fluorinated diester chosen for its likelihood of having a low value of γ_{c-t}. The study was focused on easily accessible, commercially available liquids. Hydrocarbon oils were not considered due to their tendency to denature proteins and their potential for swelling PDMS. Teflon capillaries were used to ensure that the fluorinated carrier fluid always preferentially wet the channel as a result of the low interfacial tensions between Teflon and fluorinated oils. The value of interfacial tension between SID and LDAO was measured over a period of less than about 10 minutes. After the plugs of LDAO and SID were kept in contact for about several minutes in the capillary, a change from engulfing to non-engulfing was sometimes observed, presumably due to changes in interfacial tensions. The carrier fluid, the reagent, and the third liquid were pre-equilibrated before interfacial tension measurements. The values of interfacial tensions (γ) were presented as an average (one standard deviation based on four measurements).

In all the cases, the criteria of interfacial tensions correctly predicted whether engulfing happened (bad spacer, N) or did not happen (good spacer, Y) (Table 1). From these measurements, combinations of liquids satisfying non-engulfing conditions were identified. SID plugs were good spacers when FC3283/PFO (about 10:1, v:v) was used as the carrier fluid. SID plugs were bad spacers for water plugs if the carrier fluid was FC3283 or FC40. Similarly, DTFS plugs were good spacers for both water plugs and plugs of about 0.1% LDAO if the carrier fluid was FC3283/PFO (about 10:1, v:v).

TABLE 1
Experimentally Tested Predictions of Engulfing
Based on Interfacial Tensions

| | Carrier | Third | | | | | | |
|---|---|---|---|---|---|---|---|---|
| | Fluid | Liquid | Reagent | γ_{c-t} | γ_{c-r} | γₜ₋ᵣ | Good Spacer? | |
| Entry | (c) | (t) | (r) | (mN/m) | (mN/m) | (mN/m) | Prediction | Experiment |
| 1 | FC3283 | SID | water | 8.1 ± 0.1 | 50 ± 2 | 40 ± 1 | N | N |
| 2 | FC40 | SID | water | 8.2 ± 0.1 | 54 ± 1 | 40 ± 1 | N | N |
| 3 | FC3283/PFO | SID | water | 6.3 ± 0.1 | 16.2 ± 0.3 | 40 ± 1 | Y | Y |
| 4 | FC3283 | SID | LDAO | 8.1 ± 0.1 | 14.5 ± 0.1 | 1.5 ± 0.1 | N | N |
| 5 | FC40 | SID | LDAO | 8.2 ± 0.1 | 11 ± 1 | 1.5 ± 0.1 | N | N |
| 6 | FC3283/PFO | SID | LDAO | 6.3 ± 0.1 | 10 ± 2 | 1.5 ± 0.1 | N | N |
| 7 | FC3283/PFO | SID | LDAO | 6.5 ± 0.1 | 14.4 ± 0.5 | 8.89 ± 0.03 | Y | Y |
| 8 | FC3283 | DTFS | water | 4.2 ± 0.3 | 50 ± 2 | 25.8 ± 0.1 | N | N |
| 9 | FC40 | DTFS | water | 4.9 ± 0.2 | 54 ± 1 | 25.8 ± 0.1 | N | N |
| 10 | FC3283/PFO | DTFS | water | 4.0 ± 0.2 | 16.2 ± 0.3 | 25.8 ± 0.1 | Y | Y |
| 11 | FC40 | DTFS | LDAO | 4.9 ± 0.2 | 11 ± 1 | 16 ± 2 | Y | Y |
| 12 | FC40 | DTFS | LDAO | 4.5 ± 0.2 | 20.0 ± 0.3 | 14.3 ± 0.1 | N | N |
| 13 | FC3283/PFO | DTFS | LDAO | 4.0 ± 0.2 | 10 ± 2 | 16 ± 2 | Y | Y |

To be predictive, interfacial tensions must be measured over a period of time to account for potential cross-reactivity of liquids and extraction of components from one liquid to another. When DTFS was used with about 0.1% LDAO as the reagent and FC40 as the carrier, DTFS did not engulf a plug of about 0.1% LDAO until the two liquids were kept in contact for about several minutes. To understand this change from non-engulfing to engulfing, the interfacial tensions were measured before and after the DTFS and about 0.1% LDAO were brought into contact. The results indicated that the DTFS/FC40 and DTFS/LDAO interfacial tensions remained constant, while the interfacial tension between FC40 and LDAO increased from about 11 to 20 mN/m in the two experiments (Table 1, entries 11 and 12). Similarly, the interfacial tension between SID and LDAO increased from about 1.5 to 8.9 mN/m over long-term contact between the two phases, and a change was observed from engulfing to non-engulfing in the three-phase system of FC3283/PFO, SID, and LDAO (Table 1, entries 6 and 7). These changes in interfacial tension may be attributed to the extraction of LDAO by DTFS and SID, and they could explain the observed changes of engulfing behavior.

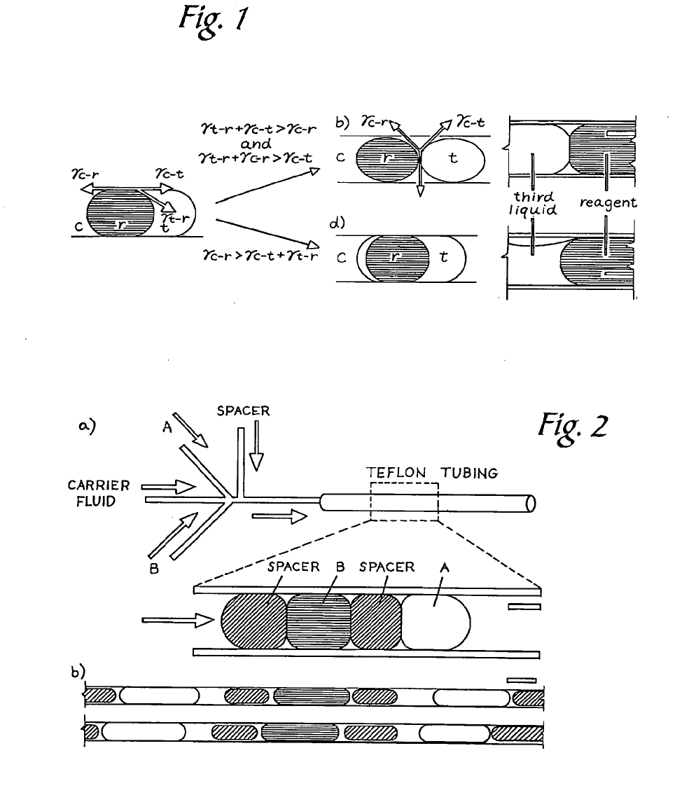

Referring to FIG. 2, in order to confirm that plugs of the identified non-engulfing third liquids were indeed effective as spacers, experiments using SID plugs were performed to separate aqueous plugs of different viscosities in Teflon tubing. Referring to FIG. 2a, a schematic of the microfluidic device used was shown on the top. The carrier fluid used was FC70/PFO (about 10:1, v:v), and the spacer was SID. Fluid A was about 0.07 M Fe(SCN)₃ and about 0.21 M KNO₃. Fluid B was about 30% glycerol. A microphotograph of the plugs flowing in the Teflon tubing was shown at the bottom. Flow rates for carrier fluid, A, B, and the spacer were about 4 μL/min, about 2 μL/min, about 2 μL/min, and about 2 μL/min, respectively. Referring to FIG. 2b, microphotographs of plugs in two side-by-side PDMS channels resulting from splitting an array of larger plugs were shown. The channels had a square cross section of about 200×200 μm². The viscous solution had about 70% glycerol. The nonviscous solution was water. Carrier fluid was FC3283/PFO (about 10:1, v:v).

Still referring to FIG. 2, without SID plugs, the viscous and nonviscous reagent plugs quickly coalesced after traveling in the channels for less than about 10 cm. Upon insertion of SID plugs, the four plugs came together (as shown in FIG. 2a) as a result of relative motion but remained in this state without coalescing. Although the plugs in FIG. 2a were visualized after traveling about 20 cm, no changes in the plugs were observed until they exited the channel (about 40 cm). While flow rates of less than about 10 μL/min are typically used for protein crystallization experiments, these experiments indicated that SID plugs were effective spacers under flow rates up to 40 μL/min (the highest flow rates tested). In these experiments, the plugs were flowing in Teflon capillaries with circular cross section. In commonly used PDMS channels with rectangular cross sections, relative motion, and therefore the coalescence of plugs, may be easier than in circular capillaries, as a result of the thicker layer of carrier fluid in the corners of the channels with rectangular cross sections.

To test spacers in square channels, alternating plugs of viscous and nonviscous solutions separated by SID plugs were generated and injected into a silanized PDMS device. This device was previously designed and used to split an array of large plugs (about 160 nL) into eight arrays of smaller (about 20 nL) plugs. The plugs flowed smoothly through the square PDMS channels, and every plug, including the spacers, was evenly split into two at each splitting junction (FIG. 2b). The viscous and nonviscous plugs remained separated by SID spacer plugs throughout the process. This experiment demonstrated that SID plugs can also act as spacers in square channels made of PDMS, and that reagent plugs separated by SID plugs can be manipulated and split in PDMS devices.

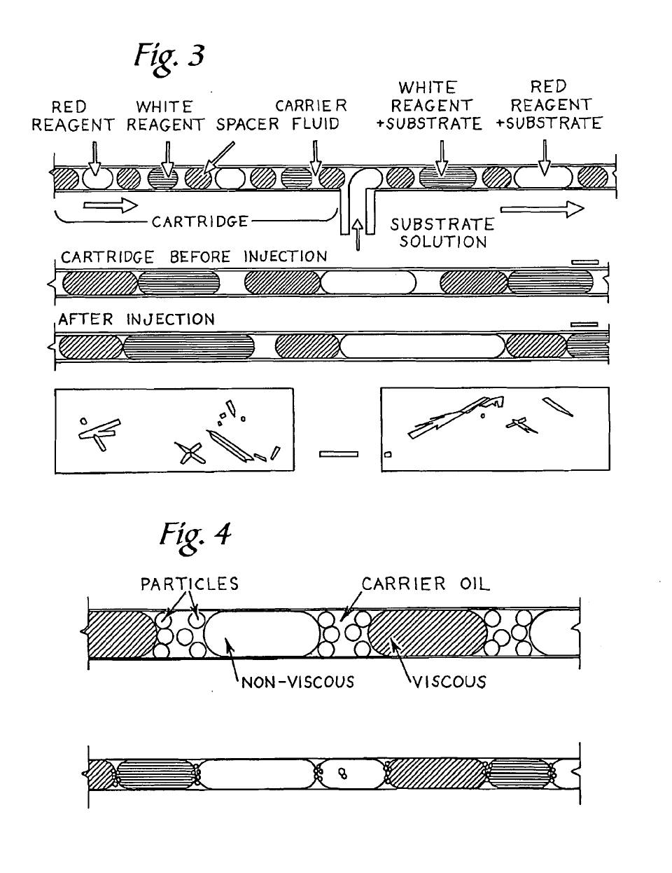

Referring to FIG. 3, SID's compatibility with injection using a T-junction microfluidic device was tested. Referring to FIG. 3a, a schematic of the T-junction microfluidic device used for injecting plugs from a preloaded cartridge with a substrate solution was shown. The plugs were about 30% aqueous glycerol (colorless) and an aqueous solution of about 0.07 M Fe(SCN)₃ (red) separated with SID plugs. Referring to FIG. 3b, microphotographs of the cartridge before (top) and after injection (bottom) with a colorless solution were shown. Flow rates for the substrate, the plugs were about 0.4 μL/min and about 1.0 μL/min, respectively. Referring to FIG. 3c, protein Tdp1 crystallized in the presence of SID plugs was shown.

One application for the third liquid could be to separate plugs of different reagents with different viscosities in pre-loaded cartridges. Still referring to FIG. 3, for applications ranging from protein crystallization to chemical screening to enzymatic assays, plugs from the cartridge need to be injected with a stream of a substrate solution using a T-junction (FIG. 3a). An array of alternating plugs of viscous (colorless) and nonviscous (red) aqueous solutions separated by a SID plug was formed (FIG. 3b). This array of plugs was combined with a stream of colorless substrate solution through a T-junction. As shown by the colors of plugs in FIG. 3b, the viscous and nonviscous plugs were separated by SID plugs before and after injection. No coalescence or cross-contamination between the plugs occurred in this process, and every aqueous plug in the array was injected with a constant volume of the substrate solution, which was verified by comparing the lengths of plugs before and after injection (FIG. 3b). These experiments confirmed that the reagent plugs separated by SID plugs could be manipulated in channels and are compatible with injection in a T-junction.

To ensure that SID is also compatible with crystallization of proteins, a human Tdp1 protein was crystallized in the presence of SID plugs. Tdp1 (tyrosyl-DNA phosphodiesterase 1) is an eukaryotic enzyme that hydrolyzes the tyrosine-DNA phosphodiester linkage, and the crystal structure of this protein has been previously reported. Alternating plugs of SID and the crystallization solution (about 22% PEG-3000, about 0.2 M NH₄Ac, about 0.1 MHEPES buffered at pH about 7.5) were formed in a Teflon capillary and injected with a stream of Tdp1 solution through a T-junction. Crystals of Tdp1 appeared in the resulting plugs after incubation for about 4 days, indicating that the spacer is compatible with protein crystallization, at least for this protein. To use SID extensively for protein crystallization, the interactions between SID and common crystallization reagents could be characterized. Such interactions include the solubility of organic additives in SID, the stability of SID over long-term contact with acidic or basic reagents, the stability of proteins in contact with SID, and the possible loss of proteins into SID. Preliminary experiments indicated that SID was stable when placed next to aqueous plugs of pH typical to protein crystallization (pH about 4.5 to 8.5). Membrane proteins are solubilized using detergents, and their crystallization in plugs requires special handling.

### Example

Materials. The glycerol solutions were made in water, and the percentage concentrations were by volume unless otherwise stated. The three carrier fluids were fluorocarbons used with or without the surfactant 1,1,2,2-tetrahydroperfluorooctanol (PFO), provided by Alfa Aesar, MA: (1) FC40, provided by Acros Organics, NJ; (2) FC70; and (3) FC3283, both provided by 3M, MN. 1,3-Diphenyl-1,1,3,3-tetramethyldisiloxane (SID) was purchased from Gelest, PA. Dimethyl tetrafluorosuccinate (DTFS) was obtained from Synquest, FL. Protein Tdp1 (N-terminal truncation (Δ1-148) of the human tyrosyl-DNA phosphodiesterase with an N-terminal His-tag, expressed in Escherichia coli) was provided by deCODE Biostructures, WA. The protein solution was provided frozen, at a concentration of about 6.7 mg/mL in a buffer containing about 250 mM NaCl, about 15 mM Tris (pH about 8.2), and about 2 mM Tris(2-carboxyethyl)-phosphine (TCEP). A detailed description of the protein expression and purification can be found in Interthal, H.; Pouliot, J.; Champoux, J. Proc. Natl. Acad. Sci. U.S.A. 2001, 98, 12009-12014, the entirety of which is incorporated herein by reference. N,N-Dimethyldodecylamine N-oxide (LDAO) was purchased from Fluka, Switzerland.

Measuring Interfacial Tensions. Interfacial tensions were measured using the pendent drop method on Advanced Digital Automated Goniometer, Model 500, from Rame'-Hart Instrument, NJ, with data analysis by software DROPimage Advanced version 1.5.04. To obtain the equilibrium interfacial tensions in the three-phase system of FC40-LDAO-DTFS, the three phases were first pre-equilibrated by combining and extensively mixing equal volumes of each phase in a vial before interfacial tension measurement. To obtain the equilibrium interfacial tensions in the three-phase system of FC3283-LDAO-SID, the three phases were pre-equilibrated by combining and keeping the three phases in a vial for about 24 hours with only occasional gentle shaking (to prevent the formation of a stable emulsion). Interfacial tensions were then measured between every two phases.

Visualizing the Interface between the Third Liquid and the Reagent Plug. An array of alternating third liquid and reagent plugs was formed by aspirating the third liquid, the carrier fluid, and the reagent solution into a piece of Teflon tubing (about 200 μm i.d.) prefilled with carrier fluid. To visualize the third liquid-reagent interface, plugs were manually driven back and forth using a syringe connected to the tubing until the third liquid and the reagent plug came into contact. Microphotographs of the interfaces were taken using a Leica MZ 12.5 stereoscope equipped with a Spot Insight color digital camera (Model 3.2.0).

Separating Plugs of Different Viscosities with Plugs of the Third Liquid. PDMS microfluidic devices with channels of square cross sections (about 200×200 μm²) were fabricated by rapid-prototyping soft lithography. Alternating plugs of a viscous solution (about 30% glycerol) and a nonviscous aqueous solution (a mixture of about 0.07 M Fe(SCN)₃ and about 0.21 M KNO₃) were generated in a microfluidic device using FC70/PFO (about 10:1, v:v) as the carrier fluid (FIG. 2a). A stream of the third liquid was introduced downstream of the point of alternating plug formation so that a plug of the third liquid was inserted between every pair of viscous and nonviscous plugs. Teflon tubing (about 200 μm i.d.) was connected to the outlet of the PDMS channel to extend the flow path. Microphotographs of the droplets were taken at different points along the flow path. To test if the plugs coalesced without the third liquid, a control experiment was performed without the stream of the third liquid.

Injecting a Substrate Stream into Reagent Plugs Separated by Plugs of the Third Liquid. A T-junction microfluidic device (FIG. 3a) was fabricated from a piece of PDMS imprinted with the channel features and a glass slide. The PDMS piece and the glass slide were first plasma oxidized and then sealed together to form the channels. The channel surface was rendered hydrophobic by silanization as described previously in Roach, L. S.; Song, H.; Ismagilov, R. F. Anal. Chem. 2005, 77, 785-796, the entirety of which is incorporated herein by reference. A hydrophilic glass capillary was inserted from the vertical branch to the junction point of the T-junction and used to inject substrate solution. The horizontal branches of the T-junction were connected to Teflon tubing. An array of alternating plugs of viscous and nonviscous solutions separated by plugs of the third liquid was driven through the Teflon tubing connected to the horizontal branch of the T-junction, and the substrate was injected from the glass capillary. The resulting plugs were collected in the Teflon tubing connected to the downstream horizontal branch of the T-junction. The carrier fluid was FC3283/PFO (about 10:1, v:v). Water was used in this experiment to mimic the substrate solution.

Crystallizing Tdp1 in the Presence of SID. Alternating plugs of the precipitant (about 22% PEG-3000, about 0.2 M NH₄Ac, about 0.1 M HEPES buffered at pH about 7.5) for Tdp1 and plugs of SID were aspirated, using FC3283/PFO (about 10:1, v:v) as the carrier fluid. The plugs were injected with a stream of Tdp1 solution using the same method described in the previous section. The resulting plugs of crystallization trials and plugs of the third liquid were flowed into a silanized glass capillary. The capillary was sealed and incubated at about 23° C. and checked about every 2 days for crystal formation. Protein crystals were observed in about 50% of the plugs on the fourth day of incubation.

Preparation of Glass bubbles. Scotchlite glass bubbles (Type S22, density of about 0.22 g/cc, obtained from 3M Corp) were slowly poured into a stack of clean 3 inch sieves (Fisher) of 230 meshes and 200 meshes and shook for about 20 minutes. Those retained on the 200 mesh sieve (about 63-75 μm size) were collected in a 35×10 mm Petri dish (BD Biosciences) and oxidized in a Plasma Prep II plasma cleaner (SPI Supplies, West Chester, Pa.) for about 100 seconds to generate silanol groups. The bubbles were then incubated at room temperature for about 10 minutes in a mixture of about 10 mM 1H,1H,2H,2H-perfluorooctyltrichlorosilane (United Chemical Technologies, Inc.) in anhydrous hexadecane (Aldrich). After silanization, the glass bubbles were rinsed with ethanol extensively and baked for about 1 hour at about 110° C. Then they were suspended in FC40 (a fluorinated oil, 3M, St. Paul, Minn.) to form an about 10% (w/v) solution. The glass bubble solution was shaken before use.

Automated Generation of Cartridge. A 96-well plate was placed in a plastic holder mounted on a laboratory-built stepping motor-driving x-y-z translation robot. The robot could directly move to a specific position or perform a sequence of preset movements. The robot was controlled by an integrated TTL pulse generator (custom-built, Sunrise Electric Co., Hangzhou, China) through a software program written by LabVIEW. The LaVIEW program could also control a PHD 2000 syringe pump (Harvard Apparatus, Holliston, Mass.) to perform precise volume aspiration from the 96-well plate to the cartridge tubing.

Separating Plugs of Different Viscosities with Glass Bubbles. FC40 was loaded into a 1700 series Gastight syringe (about 50 μL, Hamilton, Reno, Nev.) with 30-gauge Teflon tubing (Weico Wire & Cable, Edgewood, N.Y.). After loaded, a 20 cm long 200 μm i.d. Teflon tubing (Zeus, Raritan N.J.) served as the cartridge was connected with the syringe. The syringe was driven manually to fill the tubing with FC40 and the syringe was attached to the PHD 2000 syringe pump. With automated operation of the robot and syringe pump, about 5 nL glass bubble in FC 70, about 10 nL FC 40 and about 40 nL protein precipitants (Wizard II (about 1.0 M ammonium phosphate, about 100 mM Tris, from Emerald Biosystems) and HR2-535 (about 50% w/v polyethylene glycol 8,000, from Hampton Research)) were sequentially aspirated from the 96-well plate into the 10 cm long Teflon tubing with a flow rate of about 10 nL/min to form a cartridge with aqueous plugs and glass bubble spacers. Two kinds of precipitants, one with high viscosity and the other with low viscosity, formed alternative plugs in the cartridge. FC 70 and FC 40 were used because FC 70 has higher viscosity and less evaporation, which could keep the glass bubble solution steady for a longer time. The FC 40 is less viscous, which helps reduce the pressure drop on the cartridge.

Referring to FIG. 4, a cartridge with aqueous plugs separated by glass bubble spacers was prepared according to the procedure discussed above. The glass bubble spacer had a size of about 63˜75 μm. The glass bubbles were silanized by vaporation and contained in FC 40. The plugs in the cartridge comprised alternative droplets of low viscosity and high viscosity protein precipitant solutions. Wizard II (about 1.0 M ammonium phosphate, about 100 mM Tris, from Emerald Biosystems) was the low viscosity solution. HR2-535 (about 50% w/v polyethylene glycol 8,000, from Hampton Research) was the high viscosity solution. The glass bubbles were demonstrated as effective spacers in separating plugs with different viscosity.

Many modifications and other embodiments of the invention will come to mind to one skilled in the art to which this invention pertains having the benefit of the teachings presented in the foregoing description; and it will be apparent to those skilled in the art that variations and modifications of the present invention can be made without departing from the scope or spirit of the invention. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A microfluidic system, comprising:
a microchannel;
a carrier fluid in the microchannel;
at least two plugs in the microchannel, wherein each plug comprises a plug fluid that is substantially immiscible with the carrier fluid;
at least one spacer in the microchannel between two plugs, wherein each spacer comprises a spacer fluid that is substantially immiscible with the carrier fluid and the plug fluid, and wherein both of the following conditions are satisfied:
(γ_{c-r}+γₜ₋ᵣ>γ_{c-t}) and
(γ_{c-t}+γₜ₋ᵣ>γ_{c-r}),
where γ_{c-r} is the interfacial force between the carrier fluid and the plug fluid,
γₜ₋ᵣ is the interfacial force between the spacer fluid and the plug fluid, and
γ_{c-t} is the interfacial force between the carrier fluid and the spacer fluid.

2. The microfluidic system of claim 1, wherein the carrier fluid comprises an oil.

3. The microfluidic system of claim 1, wherein the carrier fluid comprises a fluorinated oil.

4. The microfluidic system of claim 1, wherein the plug fluid comprises water.

5. The microfluidic system of claim 1, wherein the plug fluid comprises a detergent.

6. The microfluidic system of claim 1, wherein the spacer fluid comprises a partially fluorinated compound.

7. The microfluidic system of claim 1, wherein the spacer fluid comprises dimethyl tetrafluorosuccinate.

8. The microfluidic system of claim 1, wherein the spacer fluid comprises a siloxane compound.

9. The microfluidic system of claim 1, wherein the spacer fluid comprises 1,3-diphenyl1,1,3,3-tetramethyldisiloxane.

10. A microfluidic system, comprising:
a microchannel;
a carrier fluid in the microchannel, wherein the carrier fluid comprises a fluorinated oil;
at least two plugs in the microchannel, wherein each plug comprises an aqueous plug fluid; and
at least one spacer in the microchannel between two plugs, wherein the at least one spacer comprises a spacer fluid comprising a compound selected from the group consisting of a partially fluorinated compound and a siloxane compound.

11. A method of separating two plugs in a microfluidic channel, comprising
providing a microfluidic channel filled with a carrier fluid and at least two plugs, wherein each plug comprises a plug fluid that is substantially immiscible with the carrier fluid; and
introducing at least one spacer in the microchannel between two plugs, wherein each spacer comprises a spacer fluid that is substantially immiscible with the carrier fluid and the plug fluid, and wherein both of the following conditions are satisfied:
(γ_{c-r}+γₜ₋ᵣ>γ_{c-t}) and
(γ_{c-t}+γₜ₋ᵣ>γ_{c-r}),
where γ_{c-r} is the interfacial force between the carrier fluid and the plug fluid,
γₜ₋ᵣ is the interfacial force between the spacer fluid and the plug fluid, and
γ_{c-t} is the interfacial force between the carrier fluid and the spacer fluid.

12. The method of separating two plugs in a microfluidic channel of claim 11, wherein the carrier fluid comprises an oil.

13. The method of separating two plugs in a microfluidic channel of claim 11, wherein the plug fluid comprises water.

14. The method of separating two plugs in a microfluidic channel of claim 11, wherein the spacer fluid comprises a compound selected from a group consisting of a partially fluorinated compound and a siloxane compound.

15. The method of separating two plugs in a microfluidic channel of claim 11, wherein each plug is separated from another by a spacer.

16. The method of separating two plugs in a microfluidic channel of claim 11, wherein the microchannel has a T-junction.

17. The method of separating two plugs in a microfluidic channel of claim 11, wherein the microchannel has a substantially square shape.

18. The method of separating two plugs in a microfluidic channel of claim 11, wherein the microchannel has a substantially circular shape.

19. The method of separating two plugs in a microfluidic channel of claim 11, wherein the microchannel is made of polydimethylsiloxane.

20. A method of separating two plugs in a microfluidic channel, comprising
providing a microfluidic channel filled with a carrier fluid and at least two plugs, wherein each plug comprises a plug fluid that is substantially immiscible with the carrier fluid; and
introducing at least one spacer in the microchannel between two plugs, wherein each spacer comprises a spacer fluid comprising a compound selected from a group consisting of a partially fluorinated compound and a siloxane compound.

21. A microfluidic system, comprising:
a microchannel;
a carrier fluid in the microchannel;
at least two plugs in the microchannel, wherein each plug comprises a plug fluid that is substantially immiscible with the carrier fluid;
at least one spacer in the microchannel between two plugs, wherein each spacer comprises at least one hydrophobic particle, and wherein the spacer maintains the separation of the plugs that contact the spacer.

22. The microfluidic system of claim 21, wherein the spacer further comprises a spacer fluid, and wherein the spacer fluid is substantially immiscible with the carrier fluid and the plug fluid.

23. The microfluidic system of claim 21, wherein the at least one hydrophobic particle is selected from a group consisting of glass bubbles, silica gels, silica microspheres, hollow glass beads, and pollens.

24. The microfluidic system of claim 21, wherein the at least one hydrophobic particle is fluorinated.

25. The microfluidic system of claim 21, wherein the at least one hydrophobic particle in at least one spacer has a color different from the hydrophobic particle in other spacers.

26. The microfluidic system of claim 21, wherein the at least one hydrophobic particle is wetted by the carrier fluid.

27. The microfluidic system of claim 21, wherein the size of the at least one hydrophobic particle is about 15%-50% of the inner diameter of the microchannel.

28. The microfluidic system of claim 21, wherein the at least one hydrophobic particle has a substantial spherical shape.

29. The microfluidic system of claim 22, wherein the at least one hydrophobic particle is suspended in the spacer fluid.

30. The microfluidic system of claim 22, wherein the at least one hydrophobic particle substantially remains suspended in the spacer fluid when there is no flow in the microchannel.

31. A method of separating two plugs in a microfluidic channel, comprising
providing a microfluidic channel filled with a carrier fluid and at least two plugs, wherein each plug comprises a plug fluid that is substantially immiscible with the carrier fluid; and
introducing at least one spacer in the microchannel between two plugs, wherein each spacer comprises a spacer fluid and at least one hydrophobic particle, and wherein the spacer maintains the separation of the plugs that contact the spacer.
